(19) United States
(12) Patent Application Publication
(10) Pub. No.: US 2015/0268122 A1
(43) Pub. Date: Sep. 24, 2015

(54) Method for force calibration, force computation and force limitation in iron core linear motors

(71) Applicant: Jenny Science AG, Rain (CH)

(72) Inventor: Alois JENNY, Rain (CH)

(21) Appl. No.: 14/661,133

(22) Filed: Mar. 18, 2015

(30) Foreign Application Priority Data
Mar. 18, 2014 (DE) 10 2014 003 842.4

(51) Int. Cl. G01L 25/00; H02P 25/06

(52) U.S. Cl. CPC G01L 25/006; H02P 25/06

(57) ABSTRACT

A method for force calibration, force computation and force limitation of iron core linear motors by detecting interfering influences during the operating of the sled, wherein a winding current measured in the linear motor is used as value for these interfering forces, and the sled of the linear motor with all add-ons but without application forces over a desired travel area with a one-time calibration and, in the process, at least one interfering current value and at least one position value are recorded and stored by at least one current and position sensor per travel interval, wherein the interfering current value represents the sum of the interfering forces and, in the later application operation, the saved data record of interfering current and position values is interpolated and used as compensation value for computing the force-proportional application current of the linear motor.

### FIELD

The invention relates to a method for force calibration, force computation and force limitation in iron core linear motors by detecting interfering influences during the driving of the sled of the linear motor. Hereinafter, force computation and force limitation are understood to be interchangeable terms.

### BACKGROUND

There are applications in which the tools used for assembly or testing are clamped to the movable part of a linear motor. When tools of this type are used, the value of the force with which the parts can be joined together, tested or sensitive parts may be brought into position only with limited force is critical.

In principle, the electrical current measured in the linear motor can be used as a value for force. However, the fact that iron core linear motors have ineliminable residual magnetic forces (cogging) even when idle falsifies force measurement values. These residual forces are a result of the interaction between the permanent magnets and the iron poles of the iron core linear motors. They are not linearly, reciprocally positive/negative and are additionally still dependent on the mechanical tolerances of the particular linear motor. For these reasons, non-iron core linear motors operating without cogging force (for example, linear motors from SAMC, wwwsmac-mca.de operating on the moving coil principle) are used for force measurements.

The disadvantage of these non-iron core linear motors is that they are more voluminous than iron core linear motors of identical propelling force. Additional force sensors can be installed or arranged externally with which force can be measured and limited. This involves additional expenses, however.

Today's linear motors must be made more compactly and economically. In this context, some thought has been given on the possibility of computing force directly with compact, iron core linear motors.

The invention therefore seeks to propose a method for computing force specifically on compact, iron core linear motors.

### SUMMARY

This problem is solved according to the technical teaching of the independent claims.

While direct force measurement without the undesired forces is not possible, the undesired forces can be accurately recorded and saved with the aid of single calibration performed in advance. This data can then be used to compute force indirectly.

The method according to the invention offers for the first time precise force measurement (by eliminating undesired forces) of an operating iron core linear motor. The method consists of a single calibration of the iron core linear motor involving the detection of undesired forces in the form of recording electrical current. This recorded electrical current data is then available when movements occur in the application, thus allowing propelling forces to be precisely computed and limited.

Force measurement (force limitation) is typically desired with the linear motor arranged vertically. This means that the weight force of the sled and the customer's tool add-ons thereof act downward. It is thus advantageous to factor this weight force into the force computation. If this weight force is compensated by a spring, compressed air or magnetic preloading elements (MagSpring), this compensation force should likewise be recorded and incorporated into the force computation. This compensation force is likewise typically not constant over the path of travel. Additionally, frictional forces of the guidance also come into play which likewise need to be taken into consideration.

There are thus various undesired (parasitic) forces which compromise the accuracy of force measurement with an iron core linear motor.

In the method for calibrating iron core linear motors according to the invention, all of these parasitic forces are accurately recorded and saved in the calibration method.

With the linear motor arranged vertically, these consist of:
Residual magnetic forces (cogging, interaction between iron/magnets);
Weight force of the sled (including customer's add-ons);
Force of the weight compensation (if present), typically not constant over the path of travel;
Dynamic frictional force; and
Static frictional force.

The following terms used for the various electrical currents help illustrate the method: Iₜₒₜₐₗ, current measured during operation in the application; Iₚₐᵣₐₛ, current recorded using the calibration method; and I_{force}, current proportional to force measured during operation in the application.

With this method the same is always true in relation to the data at the same position point:

I_{force}=Iₜₒₜₐₗ−Iₚₐᵣₐₛ.

When calibration is performed, it is imperative that no application forces appear. Only the parasitic forces may act on the linear motor sled.

According to the method, the linear motor sled, including the customer's add-ons, is slowly moved along the desired travel area during calibration and the appearing electrical current (Iₚₐᵣₐₛ) and the corresponding position are recorded in a tight travel grid (with the utmost precision) by using precise current and position sensors and saved. The value of these currents then represents the sum of all parasitic forces precisely at each position point.

Following the calibration procedure, the calibration data can be verified using a simple test.

In this test, the saved data record of current (Iₚₐᵣₐₛ) and corresponding position values are interpolated and impressed in the linear motor axle according to position. When energized in this way, the linear motor sled behaves fully balanced in practice (remains “floating” at every position) when moved manually. This shows that the method has worked and that the saved electrical current-position values represent the undesired parasitic forces precisely.

When the application is run, the force-proportional current (I_{force}) can now be computed at any desired position by measuring the total current (I_{Ltotal}) and subtracting the parasitic current (Iₚₐᵣₐₛ). Scaling this I_{force} with the force constant of the iron core linear motor (Newton per ampere) yields the force currently appearing in the application. If desired, this can then be expressed as a graphic course over the entire path of travel.

On the other hand, it is possible to limit computed force-proportional current (I_{force}), force, scaled with the force constant of the iron core linear motor (Newton per ampere), to the exact force.

The achievable computational accuracy of 2-5% is sufficient for most applications. This means that the servo controller, in addition to precisely positioning the iron core linear motor axle, can also be used to compute force or record complete force/travel diagrams. This means that in many cases, additional or external force sensors, monitoring cameras or part-presence sensors are not necessary.

According to a preferred embodiment of the method according to the invention, it is initially provided that when calibration is performed beforehand, the winding current in the iron core linear motor including the weight of the customer's add-on on the sled is detected without any assembly, joining or press-in force (without application forces). (see FIG. 1)

The following steps are provided for one-time calibration.

Gathering Iₚₐᵣₐₛ (FIG. 1)

1. Preparing the sled including activated weight compensation (if present) and the weight of the customer's add-on so that the sled can move over the desired travel distance freely and without touching parts or workpieces.

2. Moving the sled at low speed over the desired travel distance (to and from or up and down) while recording position and corresponding current Iₚₐᵣₐₛ in small intervals (e.g. every 25 μm).

3. Saving the recording pair current Iₚₐᵣₐₛ and position in a calibration database.

4. Optional, simple test for verifying calibration data. Interpolating the current values Iₚₐᵣₐₛ from the calibration databank and impressing as winding current on the linear motor, corresponding to the current sled position. The sled can now be moved by hand very easily and remains “floating” stationary at each desired position within the calibrated travel distance.

5. The iron core linear motor is now individually calibrated, with assembly tolerances, uneven field strengths of the permanent magnets and the copper wire tolerances of the winding being taken into consideration.

This calibration is stored in the calibration database in the form of parameter pairs current Iₚₐᵣₐₛ/position and is now available for computing force in application operation.

If, for example, something changes on the customer's add-on on the sled or on the weight compensation, a new calibration can be easily performed to readjust the data accordingly.

The following steps are used for operation in the application:

Computing/recording computed current I_{force} (FIG. 10)

1. The calibration, according to the method above, is performed and the calibration database is available and valid.

2. Activating force measurement in the servo controller.

3. Putting the linear motor into operation according to the application and simultaneously recording the parameter pair current Iₜₒₜₐₗ with corresponding position.

4. Computing force-proportional I_{force} at all desired positions by subtracting the parasitic current Iₚₐᵣₐₛ interpolated at this position from current Iₜₒₜₐₗ. Computation is always in relation to the same position of I_{Last} and Iₚₐᵣₐₛ.

I_{force}=I_{Ltotal}−Iₚₐᵣₐₛ.

The current I_{force} is proportional to force.

5. The current I_{force} computed in step 4, scaled with the force constant, corresponds exactly to the force which must be used to press the press-in termination 6 into the workpiece 7. The scaling factor corresponds to the force constant N/A (Newton per Ampere) of the linear motor.

It is thus possible for the first time to perform force computation through a one-time, prior force calibration of an iron core linear motor, which was previously unknown and not possible.

Until now, performing force measurement required using exclusively iron-free linear motors, which have no residual magnetic force, since this residual magnetic force (cogging) falsifies the force measurement, thus rendering the gathered measurement results unusable. For iron-free linear motors, however, the weight force of the movable part (sled) of customer's add-ons, force effect of weight compensation and frictional forces must be allowed for to determine the effect force in the application.

This shows that the present method involving prior force calibration can in principle also be used with iron-free linear motors. The advantage of this is that the parasitic forces are measured directly on the object (specifically the non-linear forces in the case of a weight compensation) and are not based on technical data affected by tolerances.

The invention thus concerns a calibration method which allows for the first time not only the residual magnetic forces but also all other undesired parasitic forces to be taken into account.

These forces are recorded during calibration and are illustrated by the current Iₚₐᵣₐₛ. What all this Iₚₐᵣₐₛ represents is reflected in the force equation 1 in FIG. 2.

The current Iₚₐᵣₐₛ is stored together with the corresponding position in the calibration database of the memory in the linear motor. The calibration database contains all values over the distance traveled in the calibration procedure.

Arranged in the computation circuit of the linear motor present according to the invention are preferably a controller, an interpolation filter and a measurement device for recording current Iₚₐᵣₐₛ.

This computation circuit could optionally allow the calibration data to be verified as an additional safety. For this purpose, Iₚₐᵣₐₛ is taken from the calibration database and impressed in the linear motor according to position. When then shifted manually, the sled will remain floating at each desired position.

In the application operation, the parasitic current Iₚₐᵣₐₛ gathered from calibration is used to compute the force-proportional current I_{force}.

I_{force}=Iₜₒₜₐₗ−Iₚₐᵣₐₛ.

It is thereby now possible for the first time to limit the force by computing and limiting the current I_{force} in the iron core linear motor calibrated according to the invention. If, for example, sensitive parts need to be joined, affixed or tested, the force of the sled feed can be restricted or limited so that exactly the desired force prevails on the part to be processed

In this connection, the presence of parts or jamming of parts can be detected and recorded in a very simple manner. Should parts in the tools or on the sled become jammed during operation/assembly, this will be detected in the form of greater forces. Additional monitoring of the parts in the manufacturing process is thus unnecessary, because this is accomplished simply through the force computation of the force-calibrated iron core linear motor.

This is increasingly demanded in practice as quality and traceability become ever more important. This “inspection function” integrated in the linear motor can replace expensive optical cameras or external sensor technology.

The force-calibrated iron core linear motor according to the invention can also forgo an external force sensor, since the exact force effect on the processing parts can be computed for each sled position in real time.

The subject matter of the present invention is derived not only from the subject matter of the individual patent claims, but also from the combination of individual patent claims with one another.

All statements and features, especially the spatial layout presented in the drawings, disclosed in the documents, including the abstract, are claimed as essential to the invention insofar as they are novel over the prior art individually or in combination.

### BRIEF DESCRIPTION OF THE DRAWINGS

The invention is described below in greater detail using only one embodiment in the representative drawings. Further essential features and advantages of the invention can hereby be derived from the drawings and their descriptions.

Shown are:

FIG. 1: Schematic block diagram of an iron core linear motor for the calibration drive.

FIG. 2: Force equation 1, which indicates the sum of all parasitic forces.

FIG. 3: Graph of Iₚₐᵣₐₛ in a current/travel diagram, measured at the winding of the linear motor over the travel distance during the calibration procedure. Direction of travel is from top to bottom.

FIG. 4: The same diagram as in FIG. 3, but with direction of travel from bottom to top.

FIG. 5: The current/travel diagram with computed I_{force} in which all parasitic forces are now compensated and the iron core linear motor is moved on the path of travel.

FIG. 6: A schematic electrical current graph of the type used in FIG. 3 or 4 with parasitic current Iₚₐᵣₐₛ displayed.

FIG. 7: Graph showing the values of total current Iₜₒₜₐₗ measured in the winding during application operation.

FIG. 8: The resulting force-proportional motor current I_{force} free of parasitic forces and ascertained from the two diagrams shown in FIGS. 6 and 7.

FIG. 9: Schematic block diagram for an electronic circuit for force calibration of an iron core linear motor.

FIG. 10: The block diagram according to FIG. 1 illustrating application operation.

### DETAILED DESCRIPTION

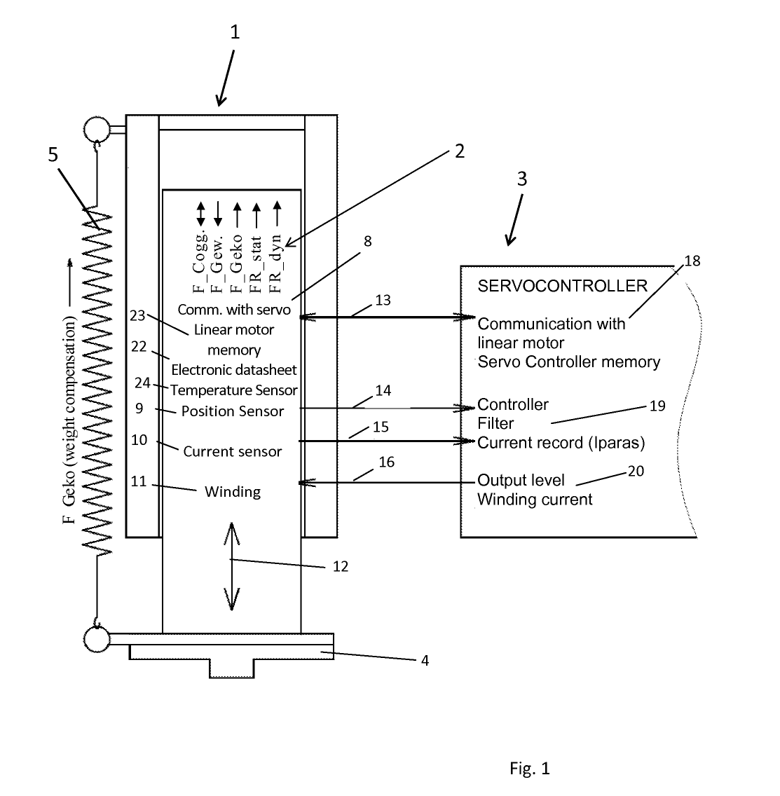

FIG. 1 shows a schematic arrangement for the force calibration of a vertically oriented iron core linear motor. This consists essentially of a stator housing 1 with the motor windings not illustrated in greater detail and the moveable sled 2 with the likewise not illustrated permanent magnets.

This hereby constitutes a vertical set-up of a linear motor with desired force measurement present in most applications.

For weight compensation of the sled weight 2 and an adapter mounted on the sled 2 by the customer, hereinafter identified as add-on 4, a weight compensation 5 is provided, which in the shown exemplary embodiment consists of a helical tension spring.

Any desired weight compensation 5 is possible. Instead of a helical tension spring other force accumulators can be used such as, for example, elastomer springs, spiral springs, disk springs, magnetic springs or pneumatic devices and similar items. It is simply a matter of the weight of the sled including the customer add-on, which, because of gravity, is oriented downward in the direction indicated by the arrow 12, being more or less compensated by the weight compensation 5.

If the motor winding in the stator housing 1 is free of current, the weight compensation 5 must be set such that the sled 2 travels to the desired position in the stator housing 1, e.g. in the middle position. Because these weight compensations are often of very rudimentary design and are accordingly imprecise, the load weight is often also overcompensated such that the sled moves upward to the limit stop in current-free state. It is now advantageous if all of these “imprecisions”, which are at best very difficult to define with technical data, are precisely recorded with force calibration.

For performing force calibration according to FIG. 1, a servo controller 3 is connected to the linear motor 1, 2.

The drawing shows plotted in the sliding range of the sled 2 the different parasitic forces, specifically

the force F_{cogg},
the force F_{gew},
the force F_{geko},
the force F_{Rstat},
the force F_{Rdyn}.

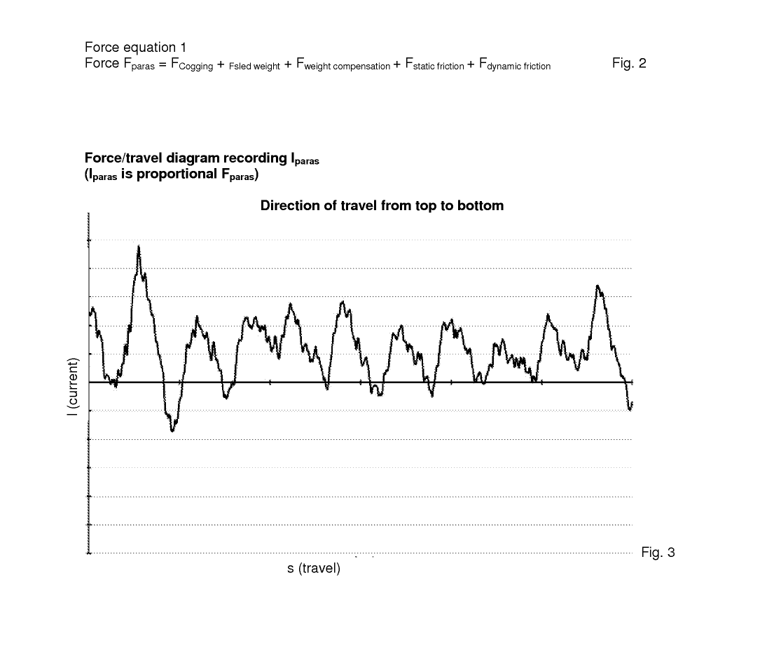

These forces are explained in equation 1 shown in FIG. 2 and yield collectively the force Fₚₐᵣₐₛ, which is identified as parasitic force. Thus according to equation 1, the parasitic force Fₚₐᵣₐₛ is the sum of the five specified forces (F_{cogg}+F_{gew}+F_{geko}, +F_{Rstat}, +F_{Rdyn}.).

When the force calibration method is performed, these parasitic forces are recorded by the corresponding servo controller 3 and saved to the calibration database.

For this purpose, a communication module 8 having a signal path 13 to the externally present servo controller 3 is arranged in the stator housing. The communication module 8 additionally features a memory 23 for storing the electrical current value Iₚₐᵣₐₛ in relation to the particular position value measured during the calibration method.

Likewise stored in the communication module is a so-called electronic datasheet 22 in which all parameters such as, for example, individuality, resistance and force constant of the iron core linear motor are stored. A temperature sensor 24 is also arranged in the communication module 8.

Arranged next to the communication module 8 is another position sensor 9 which can run on the basis of a desired position detection method. It can run on the basis of an optical, magnetic, inductive or capacitive scanning method.

It is essential that a certain position value is generated or can be computed per travel interval of the sled feed 2 (incremental measurement).

In a preferred embodiment of the invention, a digital position value is recorded every 25 μm travel interval or less and is assigned the electrical current value Iₚₐᵣₐₛ. This Iₚₐᵣₐₛ is measured by a current sensor 10 likewise arranged in the stator housing 1. The current sensor can operate by exploiting the Hall effect.

Additionally, one or even multiple windings 11 are of course arranged in the stator housing 1 which, together with the permanent magnets in the sled 2, form the drive unit.

Running current through the winding 11 can thus move the sled 2 up and down in the stator housing in the direction indicated by the arrow 12.

Additionally, the digital travel measurement data recorded by the position sensor 9 are fed via a line 14 to a computation circuit 19 which in turn contains a controller, filter and current recording.

At this point it is important that the current sensor measures the current in the one or more windings 11 while the sled 2 is moved over the desired travel distance during the calibration method and processes this current Iₚₐᵣₐₛ in the computation circuit 19 and stored in the memory of the communication module 18.

There is accordingly an additional memory in the communication module 18 which is connected to the memory 23 in the stator housing 1 via the interface 13.

The processing proceeds in the form of the following method steps 1 through 5 when performing calibration in which the parasitic current Iₚₐᵣₐₛ is measured and saved:

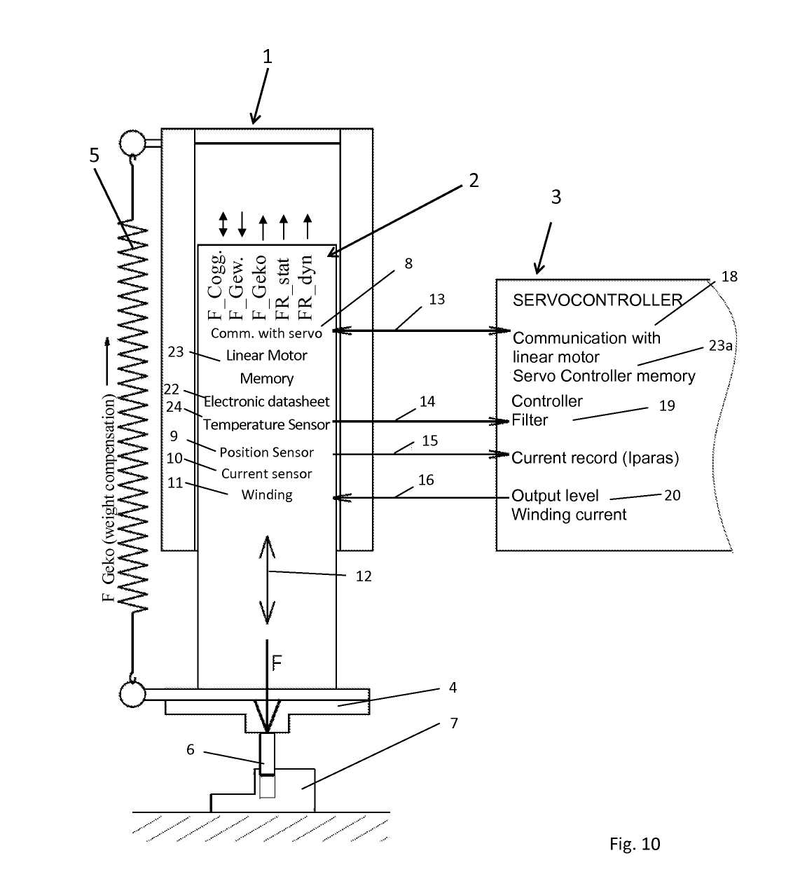

Computing/recording computed current I_{force} (FIG. 10)

1. The calibration, according to the method above, is performed and the calibration database is available and valid.

2. Activating force measurement in the servo controller.

3. Putting the linear motor into operation according to the application and simultaneously recording the parameter pair current Iₜₒₜₐₗ with corresponding position.

4. Computing force-proportional I_{force} at all desired positions by subtracting the parasitic current Iₚₐᵣₐₛ interpolated at this position from current Iₜₒₜₐₗ. Computation is always in relation to the same position of I_{Last} and Iₚₐᵣₐₛ. I_{force}=I_{Ltotal}−Iₚₐᵣₐₛ. The current I_{force} is proportional to force.

5. The current I_{force} computed in step 4, scaled with the force constant, corresponds exactly to the force which must be used to press the press-in termination 6 into the workpiece 7. The scaling factor corresponds to the force constant N/A (Newton per Ampere) of the linear motor.

Later in the application operation, this Iₚₐᵣₐₛ is subtracted from total winding current Iₜₒₜₐₗ, by means of which calibrated current I_{force} is computed. I_{force} can only be computed and not measured directly. Iₚₐᵣₐₛ is recorded during calibration and first temporarily saved together with the position in the communication module 18 memory and then stored as a calibration database in the stator housing 1 memory 23. I_{force} can be directly computed in real time in application operation.

To verify whether the parasitic current Iₚₐᵣₐₛ is correctly recorded and the internal computation runs correctly, this current Iₚₐᵣₐₛ of the winding 11 can be pilot-controlled for testing. In this state the sled 2 floats powerlessly at each desired position in the stator housing when moved manually.

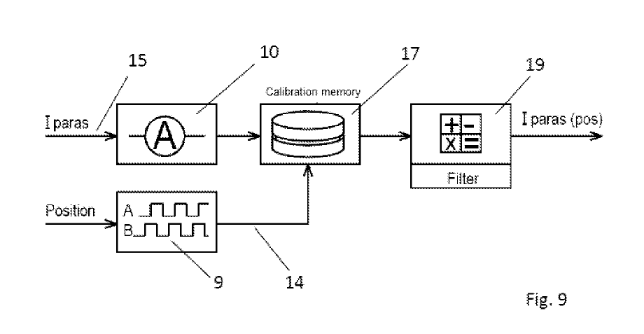

The calibration method presented above is illustrated once again using the block diagram shown in FIG. 9.

The current Iₚₐᵣₐₛ necessary for overcoming the parasitic forces is recorded by current sensor 10. At the same time, the position sensor 9 records the position and assigns it to the current value Iₚₐᵣₐₛ. This assignment of Iₚₐᵣₐₛ to position physically occurs in the computing unit 19.

In the computing unit 19 desired Iₚₐᵣₐₛ values for each intermediate position are computed for the positions between the parameter pairs Iₚₐᵣₐₛ/position via interpolation filters.

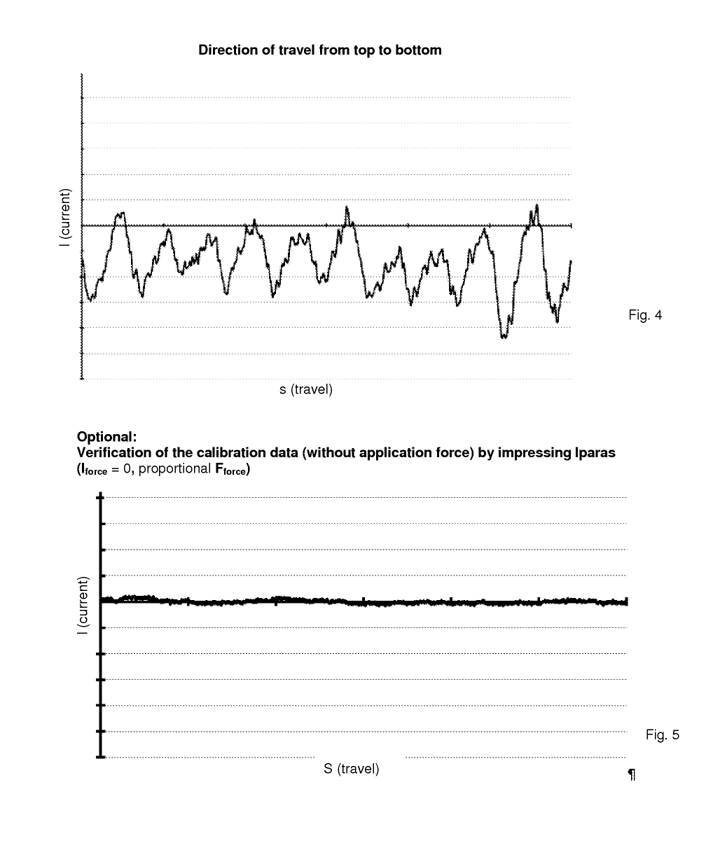

FIGS. 3 and 4 show the parasitic forces Iₚₐᵣₐₛ according to position measured in the calibration method, with FIG. 3 showing the parasitic current when the sled travels from top to bottom and FIG. 4 showing the same when the sled travels from bottom to top.

Upon close examination, it is clear that in the measurement intervals from left to right the influence of the residual magnetic force shown in FIG. 3 corresponds exactly to the residual force in the converse travel direction from left to right shown in FIG. 4. This fact establishes that the force calibration can be performed independently of the direction of travel.

Also interesting is the value of the current I_{force} illustrated in FIG. 5. This figure shows an original diagram recorded using the computation circuit 19 according to the invention. The recording was made without load imposed by application forces, and the current I_{force} shows the correctly expected value of 0. The influence of parasitic forces is virtually no longer visible.

It is important to realize that this profile of the parasitic current corresponds to a proportional value of the total of the parasitic forces as calculated according to the force equation 1 in FIG. 2. It is also evident that this parasitic current sharply changes reciprocally over the displacement distance of the sled 2 in the direction indicated by the arrow 12. Thus a prior force calibration of the linear motor as described in this invention is a prerequisite for force computation being possible at all.

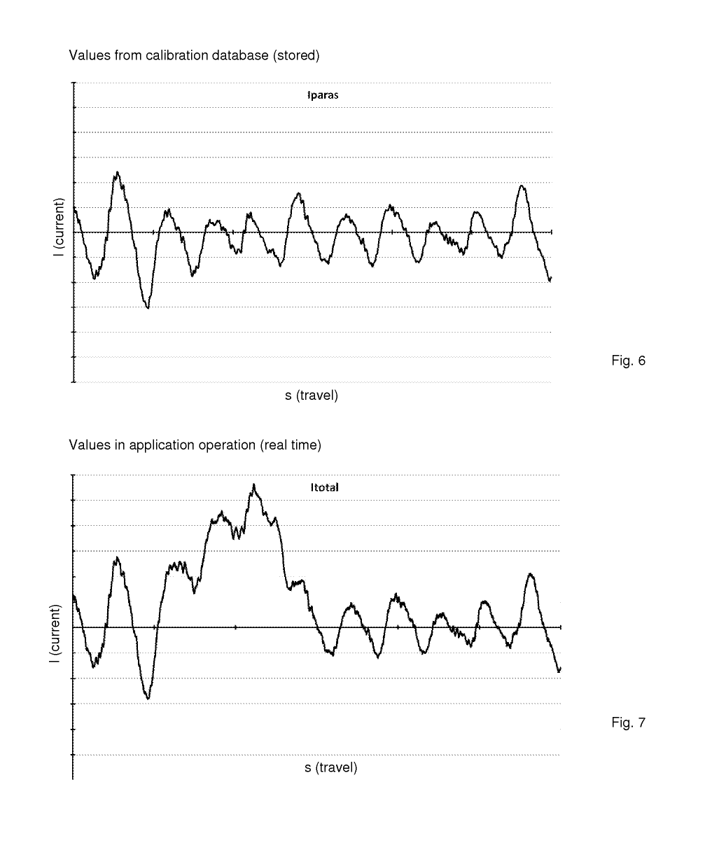

FIG. 6 shows a recording of the parasitic current Iₚₐᵣₐₛ as it is measured during calibration.

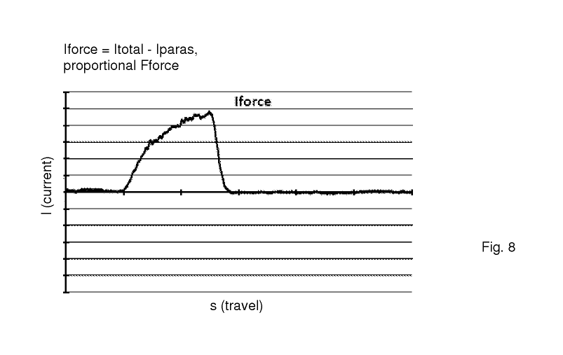

FIG. 7 shows a recording of the measured total winding current Iₜₒₜₐₗ during the application operation. If now the parasitic current Iₚₐᵣₐₛ according to FIG. 6 is subtracted from total winding current according to FIG. 7, this yields the force-proportional current I_{force} according to FIG. 8. This current I_{force} freed of parasitic forces must now only be scaled with the force constant of the linear motor (N/Ampere) to yield the desired force. This is the core of the inventive method for force calibration, force measurement and force limitation.

FIG. 10 shows the application with add-on 4 and the workpiece 7. In the exemplary embodiment illustrated, a joining part 6 should be pressed into the workpiece 7 from above. During operation, the total winding current Iₜₒₜₐₗ is measured and the parasitic current Iₚₐᵣₐₛ recorded beforehand in the calibration method is subtracted, yielding the force-proportional current I_{force}. This I_{force} can be recorded as a force-travel diagram in real time over several points of the path of travel. This force-travel diagram can be used to, for example, easily detect if the joining part 6 was present at all or if the joining part 6 is jammed.

The current I_{force} can be computed from the total current in the winding Iₜₒₜₐₗ 11 minus Iₚₐᵣₐₛ from the calibration. This means that the computed I_{force} value precisely equals the current which must be used for joining the part.

Generating the Iₜₒₜₐₗ or also the Iₚₐᵣₐₛ for the calibration is executed in the starting step 20.

It is thus possible to calibrate in advance an iron core linear motor for computing force such that the application force F on the joining part 6 in a workpiece 7 can be precisely calculated and limited. All interfering forces of the iron core linear motor are “calibrated out”.

### DRAWING LEGEND

1 Stator housing
2 Sled
3 Servo controller
4 Add-on (for 2)
5 Weight compensation
6 Press-in termination
7 Workpiece
8 Communication module (in 2)
9 Positions sensor
10 Current sensor
11 Winding
12 Arrow indicating direction
13 Signal path
14 Line
15 Line
16 Line
17 Reserve (not shown)
18 Communication module (in 3)
19 Computation circuit
20 Starting step
21 Signal path
22 Database
23 Calibration memory
24 Temperature sensor
25 Line
F_{cogg}=Cogging force
F_{gew}=Weight force
F_{geko}=Weight compensation force
F_{RStat}=Static frictional force
F_{Rdyn}=Dynamic frictional force
Iₚₐᵣₐₛ=Winding current measured during calibration which represents parasitic forces
Iₜₒₜₐₗ=Total winding current measured during operation required for movementswird
I_{force}=Computed force-proportional current

1. A method for force calibration, force computation and force limitation of iron core linear motors by detecting interfering influences during the driving of the sled, wherein a winding current measured in the linear motor is used as a value for said interfering forces, the method comprising
performing a one-time calibration by driving the sled of the linear motor with all add-ons but without application forces to move over a desired travel area and, during the movement of the sled recording at least one interfering current value and at least one position value by at least one current and position sensor per travel interval, storing said recorded at least one interfering current value and said at least one position value in a saved data record, wherein the at least one interfering current value represents a sum of the interfering forces and,
in a later application operation, interpolating the saved data record of the at least one interfering current value and the at least one position value to obtain an interpolated value; and
computing, using the interpolated value as a compensation value, a force-proportional application current of the linear motor.

2. The method for calibrating iron core linear motors as claimed in claim 1, wherein the interfering influences appear as parasitic forces which change over the travel area of the sled and are detected in the current sensor as parasitic current (Iₚₐᵣₐₛ) which is proportional to the parasitic forces.

3. The method for calibrating iron core linear motors as claimed in claim 1, further comprising assigning a certain position value of the position sensor to each current value (Iₚₐᵣₐₛ) of the current sensor in a calibration memory to obtain a current profile of the current parameter (Iₚₐᵣₐₛ) over an entire displacement travel of the sled of the linear motor.

4. The method for calibrating iron core linear motors as claimed in claim 2, wherein at least one of the parasitic forces are contained in the current value (Iₚₐᵣₐₛ), the cogging force (F_{cogg}), the weight of the sled (F_{gew}), the weight compensation (F_{geko}) arranged on the sled as well as the static frictional force (F_{Rstat}) and the dynamic frictional force (F_{Rdyn}).

5. The method for calibrating iron core linear motors according to claim 1, further comprising computing the force-proportional current in a computation circuit from the total winding current (Iₜₒₜₐₗ) and the parasitic current (Iₚₐᵣₐₛ).

6. The method for calibrating iron core linear motors as claimed in claim 1, further comprising interpolating the saved data records of current (Iₚₐᵣₐₛ) and position values, and wherein a corresponding current value Iₚₐᵣₐₛ is present at each desired position when the sled (2) is operated.

7. The method for calibrating iron core linear motors according to claim 1, wherein a controller, a filter and an electronic circuit are arranged in the computation circuit of the linear motor for recording the parasitic current (Iₚₐᵣₐₛ).

8. A method for calibrating an iron core linear motor, comprising the following steps:
1. preparing the sled including any activated weight compensation and the weight of a customer's add-on so that the sled can move over the desired travel distance freely and without touching parts or workpieces;
2. moving the sled at a low speed over the desired travel distance, recording position and corresponding current Iₚₐᵣₐₛ. in small intervals;
3. saving the recording pair current Iₚₐᵣₐₛ and position in a calibration database;
4. optionally, performing a simple test for verifying calibration data, said test comprising interpolating current values Iₚₐᵣₐₛ from a calibration databank and impressed as winding current on the linear motor, corresponding to the current sled position, moving the sled by hand, such that the sled remains floating at each desired position within a calibrated travel distance, indicating that the calibration values are then plausible;
wherein the iron core linear motor is now individually calibrated, such that assembly tolerances, uneven field strengths of permanent magnets of the iron core linear motor, copper wire tolerances of a winding of the linear motor, and force irregularities of an existing weight compensation are taken into consideration.

9. A method for operating an iron core linear motor in which, following calibration, the motor current necessary for overcoming all parasitic forces (Iₚₐᵣₐₛ) was ascertained and saved together with the corresponding position to the calibration database, and these data are used during operation in an application for computing the force-proportional current I_{force} according to the following steps:
1. activating force measurement in the servo controller;
2. putting the linear motor into operation according to the application and simultaneously recording the parameter pair current Iₜₒₜₐₗ with corresponding position;
3. computing a force-proportional I_{force} at desired positions or continuously by subtracting a parasitic current Iₚₐᵣₐₛ interpolated at each position from current
Iₜₒₜₐₗ·I_{force}=I_{Ltotal}−Iₚₐᵣₐₛ;
4. starting up the application with the current force-proportional I_{force} computed in step 3, scaled with a force constant.

10. An iron core linear motor with compensation of interfering influences during operation of the sled, wherein a per travel interval at least one current value and at least one position value are recorded and saved via at least one current and position sensor, and a certain position value of the position sensor is assigned to each current value (Iₚₐᵣₐₛ) of the current sensor in a calibration memory to obtain a current profile of a current parameter (Iₚₐᵣₐₛ) over an entire displacement distance of the sled of the linear motor, wherein the force-proportional current is computed from a total application current Iₜₒₜₐₗ and the parasitic current (Iₚₐᵣₐₛ) in a computation circuit.

11. The method for calibrating iron core linear motors as claimed in claim 2, further comprising assigning a certain position value of the position sensor (9) to each current value (Iₚₐᵣₐₛ) of the current sensor in a calibration memory to obtain the current profile of the current parameter (Iₚₐᵣₐₛ) over an entire displacement travel of the sled of the linear motor.

12. The method for calibrating iron core linear motors as claimed in claim 2, wherein a plurality of the parasitic forces are contained in the current value (Iₚₐᵣₐₛ), the cogging force (F_{cogg}), the weight of the sled (F_{gew}), the weight compensation (F_{geko}) arranged on the sled as well as the static frictional force (F_{Rstat}) and the dynamic frictional force (F_{Rdyn}).

13. The method for calibrating iron core linear motors as claimed in claim 2, wherein all of the parasitic forces are contained in the current value (Iₚₐᵣₐₛ), the cogging force (F_{cogg}), the weight of the sled (F_{gew}), the weight compensation (F_{geko}) arranged on the sled as well as the static frictional force (F_{Rstat}) and the dynamic frictional force (F_{Rdyn}).

14. The method for calibrating iron core linear motors as claimed in claim 8, wherein said small interval is 25 μm or less.
